(19) United States
(12) Patent Application Publication
(10) Pub. No.: US 2012/0249073 A1
(43) Pub. Date: Oct. 4, 2012

(54) MOTOR VEHICLE KEY AND METHOD FOR OPERATING A MOTOR VEHICLE KEY

(75) Inventors: Jeromy LAYNE, Mainz (DE); Joerg GSCHWENG, Mainz (DE)

(73) Assignee: GM GLOBAL TECHNOLOGY OPERATIONS LLC, Detroit, MI (US)

(21) Appl. No.: 13/422,004

(22) Filed: Mar. 16, 2012

(30) Foreign Application Priority Data
Mar. 18, 2011 (DE) 10 2011 014 341.6

(51) Int. Cl. H02J 7/00

(52) U.S. Cl. 320/114

(57) ABSTRACT

A motor vehicle key is provided that includes, but is not limited to a number of electronic devices, a rechargeable battery for the power supply of the electronic devices, and a device for charging the battery with energy harvesting.

### CROSS-REFERENCE TO RELATED APPLICATION

This application claims priority to German Patent Application No. 10 2011 014 341.6, filed Mar. 18, 2011, which is incorporated herein by reference in its entirety.

### TECHNICAL FIELD

The technical field relates to a motor vehicle key comprising a number of electronic devices, which are supplied with power by means of a rechargeable battery, and also relates to a method for operating such a motor vehicle key.

### BACKGROUND

Motor vehicle keys frequently comprise electronic devices, for example, an electronic closing device with a transponder, which communicates with the motor vehicle and enables the opening of locks from a certain distance. Increasingly, further functions are integrated in the motor vehicle key, which require a power supply.

Typically the power supply is provided by means of a battery, for example, a button cell, which usually needs to be replaced after discharging. This involves expenditure for the user and also produces waste. In addition, an almost discharged battery results in malfunctions of the motor vehicle key, which are very inconvenient for the user.

In view of the foregoing, at least one object to provide a motor vehicle key, which can be used over a period of time without components such as a battery, for example, needing to be renewed. It is at least another object to provide a method for operating such a motor vehicle key. In addition, other objects, desirable features and characteristics will become apparent from the subsequent summary and detailed description, and the appended claims, taken in conjunction with the accompanying drawings and this background.

### SUMMARY

A motor vehicle key is provided comprising a number of electronic devices and a rechargeable battery for the power supply of the electronic devices. The motor vehicle key further comprises a device for charging the battery by means of energy harvesting. Here and subsequently energy harvesting is understood as the use of energy sources such as vibration, ambient temperature, light, or sound to produce power. The term motor vehicle key is here also intended to include key attachments, which themselves have no closing device but which can be connected to a motor vehicle key. Such key attachments today frequently have their own electronic devices, which require a power supply.

Such a motor vehicle key has a sufficient power supply for its electronic devices. The battery need not be replaced after a relatively short time. Since motor vehicle keys are continuously exposed to vibrations during a journey or even when carried around, energy obtained from the vibrational energy by means of energy harvesting may be sufficient for the power supply.

In one embodiment, the device for charging the battery with energy harvesting is integrated with the rechargeable battery to form a module. Integrating to form a module is understood here to mean that the device for charging the battery is structurally connected to the rechargeable battery. For example, it can be disposed in a single casing or plugged together and in this way installed or replaced jointly.

Such a module requires hardly any more space inside the motor vehicle key than a conventional battery. Due to the modular design, the motor vehicle key can be configured as when using a non-chargeable battery, changes to the design to accommodate components for charging the battery are not absolutely necessary.

In one embodiment, the device for charging the battery with energy harvesting is configured to use optical energy and comprises solar cells. Alternatively or additionally, the device for charging the battery with energy harvesting can be configured for the piezoelectric use of vibrational energy. In this embodiment, vibrational energy from a movement of the motor vehicle key is converted by means of a piezocrystal into a voltage that is used to charge the battery.

Alternatively or additionally, the device for charging the battery with energy harvesting can be configured for the electromagnetic use of vibrational energy. In this embodiment, vibrational energy from a movement of the motor vehicle key is converted into current where a permanent-magnet element inside the device for charging the battery is moved by the vibrational energy or where an electrical conductor is moved in the magnetic field of a permanent magnet. Alternatively or additionally, the device for charging the battery with energy harvesting can be configured to use energy from radio waves.

According to one embodiment, the rechargeable battery is configured as a button cell. Button cells are frequently used in devices having a low power requirement, which at the same time are relatively small. These are, for example, used in the form of rechargeable nickel metal hydride rechargeable batteries having a rated voltage of 1.2 Volts.

In one embodiment, the device for charging the battery with energy harvesting is configured as a flat cylinder has the same diameter as the button cell, and rests with a base area on a base area of the button cell.

According to this embodiment, the device for charging the battery is accordingly configured as a more or less thick disk and forms a layer of a module within which the battery itself forms another layer stacked thereon or thereunder. As a result of its simple, cylindrical shape, largely corresponding to that of a button cell, this module can be integrated particularly well into the motor vehicle key.

In one embodiment, the module further comprises a device for controlling the charging process of the battery, for example, a corresponding chip or chip set.

According to an embodiment, there is provided a method for operating a motor vehicle key comprising providing a power supply to electronic devices of the motor vehicle key in the form of a rechargeable battery, and charging the battery with energy harvesting. The charging of the battery can be accomplished in particular with optical energy with piezoelectric use of vibrational energy, with electromagnetic use of vibrational energy and/or by using energy from radio waves.

### BRIEF DESCRIPTION OF THE DRAWINGS

The present invention will hereinafter be described in conjunction with the following drawing figures, wherein like numerals denote like elements, and:

FIG. 1 shows schematically a section through a motor vehicle key according to one embodiment;

FIG. 2 shows schematically a perspective view of a module with a battery for the motor vehicle key according to FIG. 1; and

FIG. 3 shows schematically an exploded view of the module according to FIG. 2 according to one embodiment.

### DETAILED DESCRIPTION

The following detailed description is merely exemplary in nature and is not intended to limit application and uses. Furthermore, there is no intention to be bound by any theory presented in the preceding background or summary or the following detailed description.

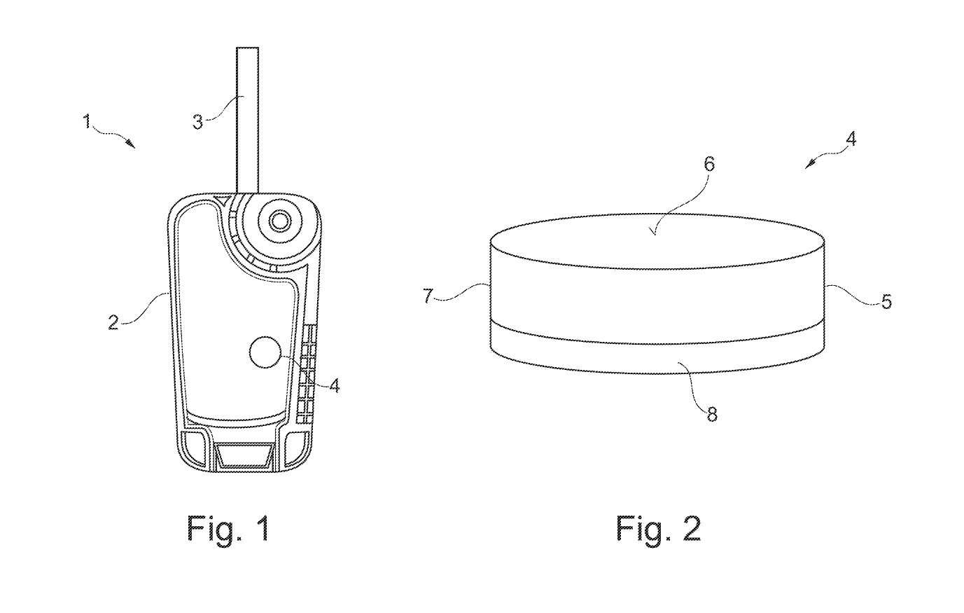

FIG. 1 shows a motor vehicle key 1, which in addition to a number of electronic devices, not shown, accommodated in a plastic casing 2, has a mechanical closing device 3, which can be inserted in a motor vehicle lock. An electronic device can additionally provide an electronic closing device. A module 4 with a battery, which is shown in detail in FIG. 2, is provided in the casing 2 for the power supply of the electronic devices.

The module 4 according to FIG. 2 comprises a rechargeable battery 5, which in the embodiment shown is configured as a button cell. The battery 5 therefore has a substantially cylindrical shape with a first base surface 6, a second base surface not shown, and a lateral surface 7. In addition to the battery 5, the module 4 comprises a device 8 for charging the battery 5. The device 8 for charging the battery is also cylindrically shaped, with its base surfaces having the same diameter as the base surfaces of the battery 5. The device 8 rests with a first base surface on the second base surface of the battery 5. Overall, the module 4 therefore also has a cylindrical shape and is only slightly higher and no wider than the battery 5 that is configured as a button cell.

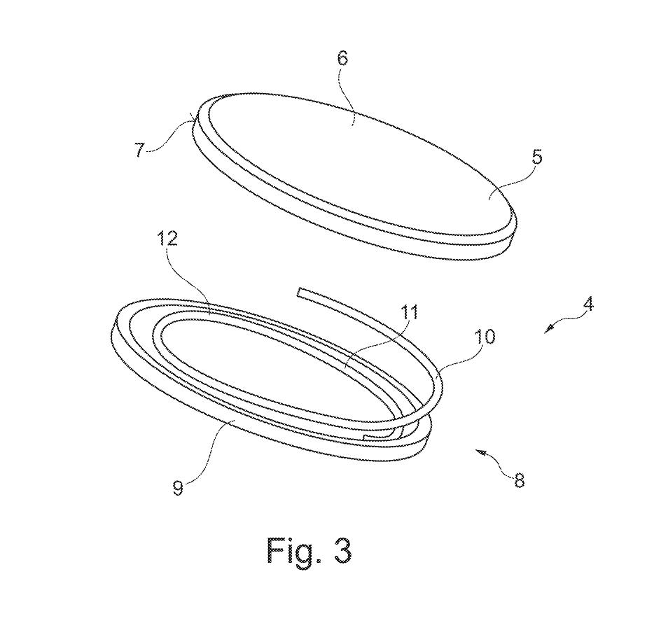

FIG. 3 shows in an exploded view details of the module 4 according to one embodiment. In this embodiment, the device 8 for charging the battery is configured for the electromagnetic use of vibrational energy and comprises a copper plate 9 with a base surface 12, which rests on the second base surface of the battery 5. A circular groove 11 is let into the copper plate 9, in which a half-ring 10 of permanent magnetic material slides.

During a movement of the motor vehicle key and therefore a movement of the module 4, the half-ring 10 slides in the groove 11. According to the induction law, a voltage is generated by the movement, which can be tapped and used to charge the battery 5. The copper plate 9 thereby serves as an electron supplier. Instead of the half-ring 10, a differently shaped permanent-magnetic element can also be provided, which slides in a groove 11 possibly shaped differently from circular.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle key comprises:
a plurality of electronic devices;
a rechargeable battery for a power supply of the plurality of electronic devices; and
a device that is configured to charge the rechargeable battery by energy harvesting.

2. The motor vehicle key according to claim 1, wherein the device is integrated with the rechargeable battery to form a module.

3. The motor vehicle key according to claim 1, wherein the device is configured to use optical energy.

4. The motor vehicle key according to claim 1, wherein the device is configured for piezoelectric use of vibrational energy.

5. The motor vehicle key according to claim 1, wherein the device is configured for electromagnetic use of vibrational energy.

6. The motor vehicle key according to claim 1, wherein the device is configured to use energy from radio waves.

7. The motor vehicle key according to claim 1, wherein the rechargeable battery is a button cell.

8. The motor vehicle key according to claim 7, wherein the device is a substantially flat cylinder having a substantially same diameter as the button cell and configured to rest with a first base surface of the device on a second base surface of the button cell.

9. The motor vehicle key according to claim 2, wherein the module further comprises a second device that is configured to control a charging process of the rechargeable battery.

10. A method for operating a motor vehicle key, comprising:
providing a power supply to a plurality of electronic devices of the motor vehicle key in a form of a rechargeable battery; and
charging the rechargeable battery with energy harvesting.

11. The method according to claim 10, wherein the charging of the rechargeable battery is accomplished with optical energy.

12. The method according to claim 10, wherein the charging of the rechargeable battery is accomplished with piezoelectric use of vibrational energy.

13. The method according to claim 10, wherein the charging of the rechargeable battery is accomplished with electromagnetic use of vibrational energy.

14. The method according to claim 10, wherein the charging of the rechargeable battery is accomplished with energy from radio waves.
